(19) United States
(12) Patent Application Publication
(10) Pub. No.: US 2025/0086523 A1
(43) Pub. Date: Mar. 13, 2025

(54) CHAINING MACHINE LEARNING MODELS WITH CONFIDENCE LEVEL OF AN OUTPUT

(71) Applicant: GM Cruise Holdings LLC, San Francisco, CA (US)

(72) Inventor: Guy Satat, Natick, MA (US)

(21) Appl. No.: 18/466,764

(22) Filed: Sep. 13, 2023

(51) Int. Cl. G06N 20/20

(52) U.S. Cl. CPC G06N 20/20

(57) ABSTRACT

Systems and techniques are provided for chaining machine learning (ML) models using a confidence level of an output of a provider model. An example method can include receiving a first output generated by a first ML model, determining a confidence level of the first output generated by the first ML model, and providing the first output of the first ML model and the confidence level of the first output to a second ML model as an input of the second ML model. The second ML model can be configured to process the first output of the first ML model and the confidence level of the first output of the first ML model to generate a second output of the second ML model.

### BACKGROUND

### 1. Technical Field

The present disclosure generally relates to machine learning. For example, aspects of the present disclosure relate to techniques and systems for chaining machine learning models using a confidence level of an output of a publisher model.

### 2. Introduction

Artificial Intelligence/Machine Learning (AI/ML) frameworks are increasingly used to perform complicated tasks with a high degree of accuracy. For example, AI/ML frameworks are often used for computer vision tasks, image processing tasks, classification tasks, prediction tasks, and automation tasks (e.g., autonomous driving, etc.), among other tasks and/or applications. Moreover, the AI/ML frameworks can be integrated with other software and/or can be used with other software. For example, an AI/ML framework can be integrated and/or used with software used by an autonomous vehicle (AV) to perform autonomous driving operations, such as a perception stack of the AV, a prediction stack of the AV, a planning stack of the AV, a control stack of the AV, and/or a software system(s) of the AV (e.g., a cruise control system, a parking assistance system, a lane keeping system, a navigation system, a sensor processing and/or sensor fusion system, a collision and/or obstacle avoidance system, a path planning system, an autopilot system, a lane centering system, an electronic stability system, and/or any other system).

In many cases, an AI/ML framework can be resource and compute intensive, which can impact the costs of implementing the AI/ML framework. Moreover, training an AI/ML framework can be very difficult and costly. For example, the amount of data used to train an AI/ML framework to achieve a certain accuracy and/or performance can be very large. Such amount of training data can be difficult to obtain and/or generate. The process of generating and/or obtaining training data can be expensive and, in many cases, may involve a large number of resources. The training process can also be expensive, as it often uses a large number of resources and can involve a large number of training and/or data processing operations. Thus, the overall training of an AI/ML framework can be expensive, inefficient, and difficult to manage, implement, and/or complete.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some aspects of the disclosed technology;

FIG. 2 is a diagram illustrating an example pipeline for machine learning model chaining, according to some examples of the present disclosure;

FIG. 3 is a diagram illustrating an example pipeline for chaining a depth map model and an object detection model, according to some examples of the present disclosure;

FIG. 4 is a flowchart illustrating an example process for chaining machine learning models with a confidence level of an output of a publisher model, according to some examples of the present disclosure;

FIG. 5 illustrates an example of a deep learning neural network, according to some aspects of the disclosed technology; and

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

As previously explained, artificial intelligence (AI) and machine learning (ML) frameworks are increasingly used to perform a variety of tasks and can often provide a high degree of accuracy. An AI/ML framework can include an AI/ML architecture, platform, software, one or more model(s), and/or component(s). In some cases, an ML workflow is split up into independent parts, which are then chained or stacked to form a chain of ML models. For example, chaining of ML models (also known as model stacking or stacked generalization) includes combining multiple ML models to execute sequentially. That is, the outputs of one model become the inputs to the next model down the train.

When an output of one model (e.g., a publisher model) is fed into another model (e.g., a consumer model), some descriptive information associated with the output of the publisher model may get lost or discarded and is not provided to the consumer model. For example, when a consumer model receives an output of a publisher model, which includes a prediction (e.g., a predicted value, a predicted class, a predicted pattern, etc.) for a given input, the output does not include a reason for such output/prediction, a level of confidence or certainty of the output/prediction, etc. As follows, training of a publisher model typically can include training of a consumer model, which can be computationally intensive and inefficient.

Described herein are systems, apparatuses, processes (also referred to as methods), and computer-readable media (collectively referred to as “systems and techniques”) for chaining machine learning models using a confidence level of an output of a publisher model. For example, a publisher model can generate an output along with a confidence level associated with the output of the publisher model. The output of the publisher model and the confidence level of the output can be provided to a consumer model as an input of the consumer model, rather than simply providing the output of the publisher model without the confidence level associated with such output. In some aspects, a consumer model can generate an output based on the processing of the output of the publisher model along with the confidence level of the output of the publisher model. The consumer model can adjust how it processes the output or portions thereof based on the confidence level, which allows the consumer model to better understand/process the output from the publisher model and/or generate a more accurate output based on the output of the consumer model.

In some examples, a consumer model may process a portion of an output of a publisher model that has a confidence level that exceeds a confidence threshold. For example, a consumer model can receive an output of a publisher model that includes a depth map that includes a depth value for each pixel of the depth map. The consumer model can also receive a confidence level that can include and/or represent a probability and/or estimate of a confidence/certainty for each depth value of each pixel of the depth map, a set of depth values in the depth map, and/or the depth map as a whole. As follows, the consumer model may process one or more pixels that have a confidence level that is above a threshold to generate an output that accounts for such confidence level.

In some aspects, training of a consumer model can be independent of training of a publisher model (or vice versa). Since a publisher model has provided a consumer model with some descriptive information about an output (e.g., a confidence level), which can be independently supervised for, retraining of a publisher model does not require subsequent retraining of a consumer model (or vice versa) nor jointly retraining a publisher model and a consumer model. In other words, providing a confidence level of an output of a publisher model to a consumer model along with the output from the publisher model may allow the publisher model to be trained without a need to also train or retrain the consumer model. Also, training of a consumer model may be performed independently of training of a publisher model. However, in other cases, a publisher model and a consumer model can be jointly trained, which can include training the consumer model to process outputs from the publisher model including confidence levels estimated for such outputs.

In some instances, a confidence level associated with an output of a publisher model can include a margin of error associated with the output of the publisher model. For example, if an output of a publisher model is a predicted numeral value, a confidence level can include a degree of certainty (or uncertainty) of the prediction along with a margin of error for the predicted numeral value. For example, if a publisher model (e.g., an object detection model) predicts a distance from an AV to a pedestrian to be 10 meters in length, a consumer model can receive a confidence level of the predicted value (e.g., 85% of certainty that the length is 10 meters) and a margin of error (e.g., 10 meters+/−2 meters) as an input. As follows, a consumer model (e.g., a path planning model) can process the predicted distance along with the confidence level and margin of error in generating a navigation route for the AV. In some examples, a confidence level associated with an output of a publisher model can additionally or alternatively include one or more values representing a confidence level associated with the output of the publisher model. For example and without limitations, in some cases, a confidence level can include a percentage or probability value, a value within a range (e.g., 0 to 1, −1 to 1, 0 to 10, 0 to 100, a fraction, etc.), a weight or bias, or any other value(s).

In some cases, an output of a consumer model can be provided to a computing system associated with an AV to perform autonomous driving operations. For example, a publisher model and/or a consumer model may include one or more ML models (e.g., an object detection model, an object classification model, a light detection and ranging (LIDAR)-based model, a radar detection and ranging (RADAR)-based model, an image data or camera-based model, a sensor fusion model, a path planning model, a control model, a semantic segmentation model, and/or a behavior prediction model, a map generator model, etc.) whose output may be used in autonomous driving operations, among others.

Aspects of the disclosed technology can improve the accuracy of output generated by machine learning model(s) by leveraging a confidence level (e.g., a degree of certainty or uncertainty) associated with an output of a publisher model. Furthermore, the systems and techniques can avoid or reduce the delay in training machine learning model(s) since retraining of a publisher model and consumer model can be done independently. The independent retraining of a publisher model and consumer model can be achieved by training/supervising the publisher model to produce confidence. Aspects of the disclosed technology can train the publisher model to produce confidence that has the same meaning every time. For example, the concept or meaning of the output of the publisher model does not change from a training job to another training job.

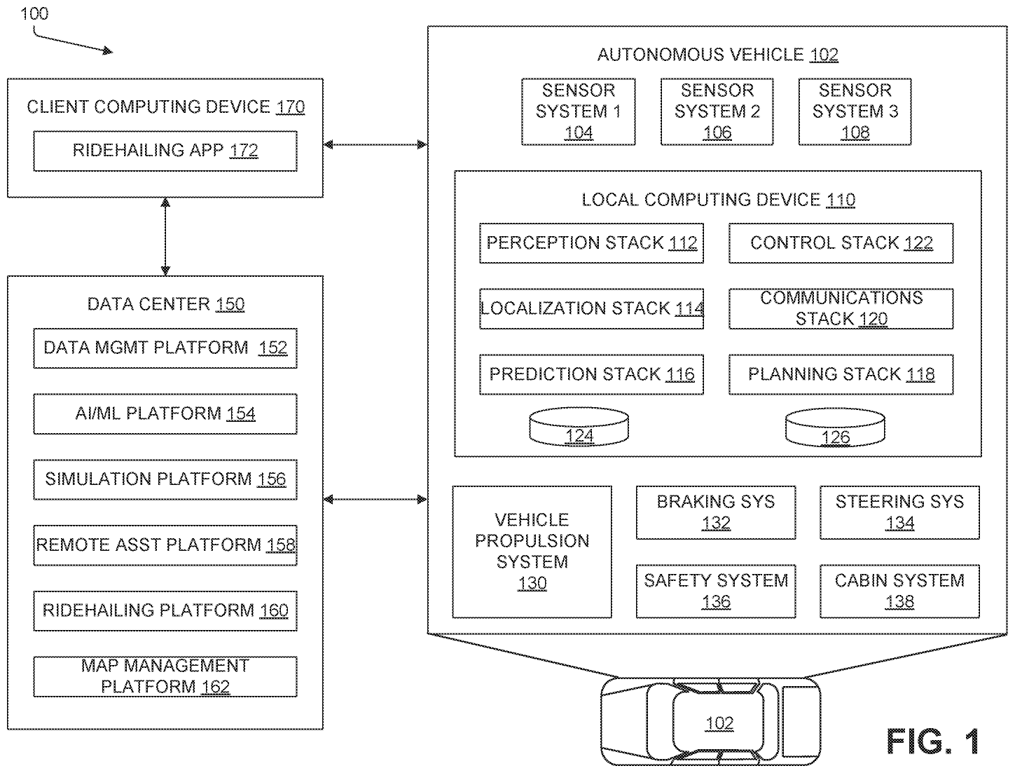

Various examples of the systems and techniques for chaining machine learning models with a confidence level of an output of a publisher model are illustrated in FIG. 1 through FIG. 6 and described below. While various examples of the systems and techniques described herein include chaining machine learning models in the context of machine learning models implemented by an autonomous vehicle, such examples are merely non-limiting illustrative examples provided for explanation purposes. One of ordinary skill in the relevant arts will recognize that the systems and techniques described herein can be used in any other contexts. For example, the systems and techniques described herein can be used to chain machine learning models with a confidence level of an output of a publisher model in any context such as, for example and without limitation, other automation and robotics contexts, computer vision contexts, etc.

Moreover, as used herein, chaining models refers to using and/or configuring one or more models to process outputs from one or more other models. For example, chaining a first model and a second model can refer to using and/or configuring the second model to process outputs from the first model as inputs (or a portion of inputs) to the second model. In some examples, chaining a first model and a second model can also include configuring the first model (or a separate model, algorithm, and/or system) to provide outputs from the first model to the second model for processing by the second model. The outputs from the first model to the second model can include or can be provided with confidence levels associated with such outputs, for processing with the outputs by the second model, as further described herein.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridehailing service (e.g., a ridesharing service), a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridehailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridehailing/ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridehailing service (e.g., a ridesharing service) via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. The client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the ridehailing application 172 (e.g., client application) to enable passengers to view the AV 102 in transit en route to a pick-up or drop-off location, and so on.

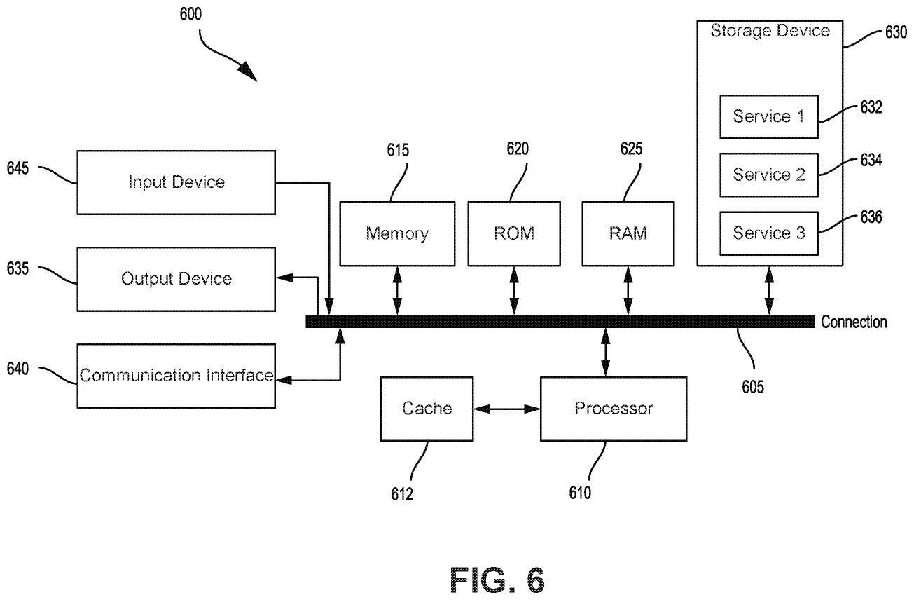

While the autonomous vehicle 102, the local computing device 110, and the AV environment 100 are shown to include certain systems and components, one of ordinary skill will appreciate that the autonomous vehicle 102, the local computing device 110, and/or the AV environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

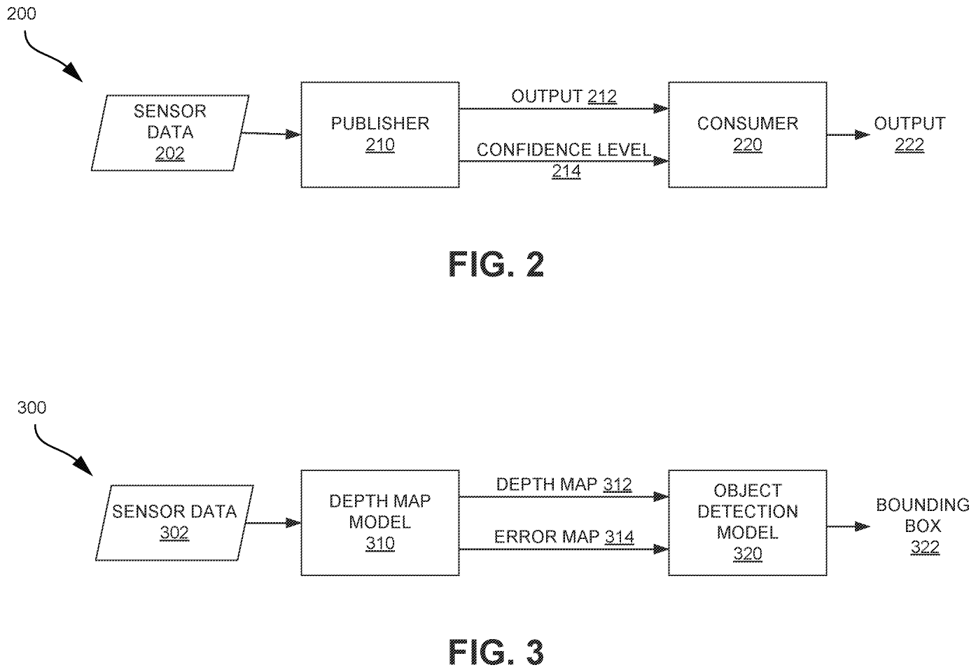

FIG. 2 illustrates an example pipeline 200 for chaining multiple machine learning (ML) models (e.g., publisher 210 and consumer 220) using a confidence level of an output of a publisher model. As shown, publisher 210 (also referred to as a provider model, a publisher model, a publisher, etc.) can be chained and/or otherwise combined with consumer 220 (also referred to as a consumer model, receiver model, etc.) where publisher output 212 is provided to consumer 220 as input. In some cases, a chain (or combination) of publisher 210 and consumer 220 may be used for various aspects of a system associated with an AV (e.g., AV 102) such as perception stack 112, localization stack 114, prediction stack 116, control stack 122, communications stack 120, planning stack 118, etc. as described below.

In some approaches, publisher 210 may receive sensor data 202 as an input. In some examples, sensor data 202 can include sensor data that is collected by one or more sensors of an AV (e.g., sensor systems 104-108 of AV 102 as illustrated in FIG. 1) such as a camera sensor, a LIDAR sensor, a RADAR sensor, an ultrasonic sensor, an IMU, a GPS, and so on. For example, sensor data 202 can include image data (e.g., grayscale images, RGB images (red, green, and blue images), depth maps, multispectral images, thermal images, tracking and/or localization measurements, ranging measurements, acoustic data/measurements, etc.) that is captured by one or more sensors.

In some aspects, publisher 210 may process sensor data 202 to generate publisher output 212. For example, the publisher 210 may include an ML model such as a computer vision model (e.g., an object detection model, an object classification model, etc.), a LIDAR-based model, a sensor fusion model, a path planning model, a control model, a semantic segmentation model, a behavior prediction model, a map generator model, etc., which is configured to process sensor data 202 based on a task of the respective model, and generate publisher output 212.

In some examples, publisher 210 can include an object classification model, which is configured to generate publisher output 212 including an object class (e.g., a vehicle, a pedestrian, a road, etc.). In some examples, publisher 210 may include a LIDAR-based model, which is configured to generate publisher output 212 including three-dimensional (3D) point clouds of the surrounding environment based on sensor data 202. In some examples, publisher 210 may include a path planning model, which is configured to generate publisher output 212 including a trajectory of AV 102 and/or navigation routes. In some examples, publisher 210 may include a semantic segmentation model, which is configured to generate publisher output 212 including label(s) of each pixel or voxel in sensor data 202.

In some cases, publisher 210 may generate confidence level 214 associated with publisher output 212. The confidence level 214 can provide internal state information relating to publisher output 212 such as a probability of certainty in publisher output 212, an accuracy estimate of publisher output 212, a margin of error of publisher output 212, a value(s) representing an estimated accuracy (and/or likelihood of accuracy) of publisher output 212, a weight or bias associated with publisher output 212, and so on. For example, confidence level 214 can include a probability value that represents the level of confidence or certainty (or a degree of certainty) of publisher output 212 (e.g., a predicted numeral value, a predicted pattern, a predicted object class, a predicted point cloud, a predicted label, etc.). In some instances, the probability value of confidence level 214 can be denoted by a numerical value ranging from 0 to 1 or a percentage (e.g., ranging from 0% to 100%).

In some instances, confidence level 214 associated with publisher output 212 may include a margin of error of publisher output 212. A margin of error can provide the uncertainty or precision associated with publisher output 212 with potential range within which publisher output 212 is likely to lie. For example, if publisher output 212 includes a predicted speed of 15 miles-per-hour (mph) for an oncoming vehicle, confidence level 214 can include a margin of error of publisher output 212 such that the predicted speed of the oncoming vehicle can be 15 mph+/−0.5 mph.

In some examples, confidence level 214 associated with publisher output 212 may include a maximum and/or a minimum value for publisher output 212. For example, if publisher output 212 includes a predicted distance between an AV and a pedestrian as 5 meters, confidence level 214 can include a maximum and/or a minimum distance for the predicted distance between the AV and the pedestrian such as ranging from 2.5 meters to 7 meters.

In some aspects, consumer 220 may receive publisher output 212 and confidence level 214 that are generated by publisher 210 as an input to consumer 220 for processing. The consumer 220 may include one or more ML models such as a computer vision model (e.g., an object detection model, an object classification model, etc.), a LIDAR-based model, a sensor fusion model, a path planning model, a control model, a semantic segmentation model, a behavior prediction model, a map generator model, etc., which is configured to process publisher output 212 and confidence level 214 to generate consumer output 222.

In some approaches, consumer 220 can process publisher output 212 and confidence level 214 to generate consumer output 222, for example, in accordance with a task of the respective ML model associated with consumer 220. For example, if publisher 210 includes an object detection model and consumer 220 includes a prediction model, consumer 220 can receive, as input, publisher output 212 that includes an object that is identified in a scene and generate consumer output 222, which includes a predicted path of the object that is identified in the scene. In some cases, consumer 220 may reason about potential errors in publisher output 212 based on evaluating publisher output 212 with confidence level 214 associated with publisher output 212.

In some examples, in processing publisher output 212 and confidence level 214 to generate consumer output 222, consumer 220 may process at least a portion of publisher output 212 based on confidence level 214 associated with publisher output 212. That is, consumer 220 may process a portion of publisher output 212 that has confidence level 214 that exceeds a confidence threshold. For example, consumer 220 may identify a portion of publisher output 212 that has sufficient certainty (e.g., having a degree of certainty that is above a confidence threshold or having a degree of uncertainty that is below an uncertainty threshold). In some examples, in processing publisher output 212 and confidence level 214 to generate consumer output 222, consumer 220 may process a portion of publisher output 212 having a confidence level above a threshold (e.g., as determined based on confidence level 214) and ignore/dismiss another portion of publisher output 212 having a confidence level below the threshold (e.g., as determined based on confidence level 214). In other examples, in processing publisher output 212 and confidence level 214 to generate consumer output 222, consumer 220 may vary how much weight/bias it applies to publisher output 212 (and/or portions thereof) based on confidence level 214 associated with publisher output 212. In some aspects, a ML model can consume the information relating to confidence level and leverage it in a nonlinear way to minimize the loss function that it is trained for. For example, consumer 220 may receive output 212 and confidence level 214 from publisher 210 and leverage them in a nonlinear way towards minimizing the loss function that consumer 220 is trained for.

In some cases, confidence level 214 can be supervised by a value of a loss function. For example, confidence level 214, when training publisher 210 and/or consumer 220, can be determined based on a difference between a ground truth and output 212 (e.g., a prediction). As previously described, since internal state information relating to publisher output 212 (e.g., confidence level 214) is provided to consumer 220, if publisher 210 needs to be retrained with output 212 and confidence level 214, consumer 220 is not necessarily retrained. In other words, publisher 210 can be retrained without having to retrain consumer 220. Also, consumer 220 can be retrained without having to also retrain publisher 210.

In some examples, an error can be supervised to produce the error of the output and/or the ML model (e.g., publisher 210, consumer 220, etc.). For example, the error of the output can be determined based on Error_output=|model_output−ground_truth_output|. In some approaches, a confidence can be predicted based on a softmax function or a cross entropy loss function. The scale/bias and the meaning of the output (e.g., error or confidence) may be consistent between training jobs.

In some aspects, consumer 220 can provide consumer output 222 to a computing system associated with an AV (e.g., local computing device 110 of AV 102, a control system of AV 102, data center 150, etc.) to facilitate autonomous driving operations. For example, various stacks such as perception stack 112, localization stack 114, prediction stack 116, control stack 122, communications stack 120, planning stack 118, etc. can implement a combination of publisher 210 and consumer 220 that are chained using publisher output 212 and confidence level 214 as described above.

While example pipeline 200 illustrates chaining two ML models (e.g., publisher 210 and consumer 220), any applicable number of ML models can be chained to execute sequentially. For example, consumer output 222 along with a confidence level associated with consumer output 222 can be provided to another ML model as input for processing and generating an output. As another example, publisher output 212 and confidence level 214 can be provided to consumer 220 along with an output and associated confidence level from one or more other models.

Moreover, while the pipeline 200 in FIG. 2 is described with respect to sensor data (e.g., sensor data 202) processed by publisher 210, such sensor data is merely a non-limiting illustrative example of a type of data input to publisher 210. In other examples, the input to publisher 210 can include other type of data in addition to or instead of sensor data. For example, in other cases, the input to publisher 210 can include a content item (e.g., a file, a log, a document, a data object, a media item or multimedia item, etc.), a set of values, a string, a feature map, a prediction, a map, statistics, an encoded input, a range of values, a category or class, a vector, a list, data indicating a pattern(s), a dataset, a computer-generated image(s)/frame(s), sample properties, coordinates, input features, a mask, a segmentation map, a binarized map, text, numbers, calculations, etc.

FIG. 3 illustrates an example pipeline 300 for chaining a depth map model 310 and an object detection model 320. In this example pipeline 300, depth map model 310 (similar to publisher 210 as illustrated in FIG. 2) can be chained and/or otherwise associated with object detection model 320 (similar to consumer 220 as illustrated in FIG. 2). In other words, through pipeline 300, object detection model 320 can receive outputs from depth map model 310 for processing by object detection model 320.

In some examples, depth map model 310 may receive sensor data 302 as input for processing. For example, sensor data 302 can include camera data, LIDAR data, time-of-flight (ToF) sensor data, RADAR data, etc., captured by one or more sensors (e.g., sensor systems 104-108 of AV 102 as illustrated in FIG. 1).

In some aspects, depth map model 310 can process sensor data 302 to generate depth map 312. For example, depth map model 310 can construct depth map 312 for each pixel by processing one or more sensor data (e.g., camera data, LIDAR data, ToF sensor data, or a combination thereof) included in sensor data 302. Each pixel in depth map 312 can have a depth value that is calculated by processing sensor data 302.

In some cases, depth map model 310 can generate error map 314, which comprises a probability of an error in the depth value of each pixel (e.g., a pixelwise error). In some examples, error map 314 can be indicative of a probability of certainty/confidence or a probability of uncertainty with respect to the depth value of each pixel.

The object detection model 320 can receive depth map 312 and error map 314 that are generated by depth map model 310 as input. The object detection model 320 may process depth map 312 and error map 314 to generate bounding box 322 as output.

In some instances, in processing depth map 312 and error map 314, object detection model 320 may identify one or more pixels of depth map 312 whose probability of an error is below an error threshold. The object detection model 320 may generate bounding box 322 based on the one or more pixels of depth map 312 whose probability of an error is below an error threshold. In some cases, object detection model 320 (e.g., consumer 220) can consider potential locations of a target within the provided distance+/−error. For example, object detection model 320 (e.g., consumer 220) can consider the probability of a point or pixel on depth map 312 to exist in a range of potential locations. This may be useful for segmentation and clustering algorithms.

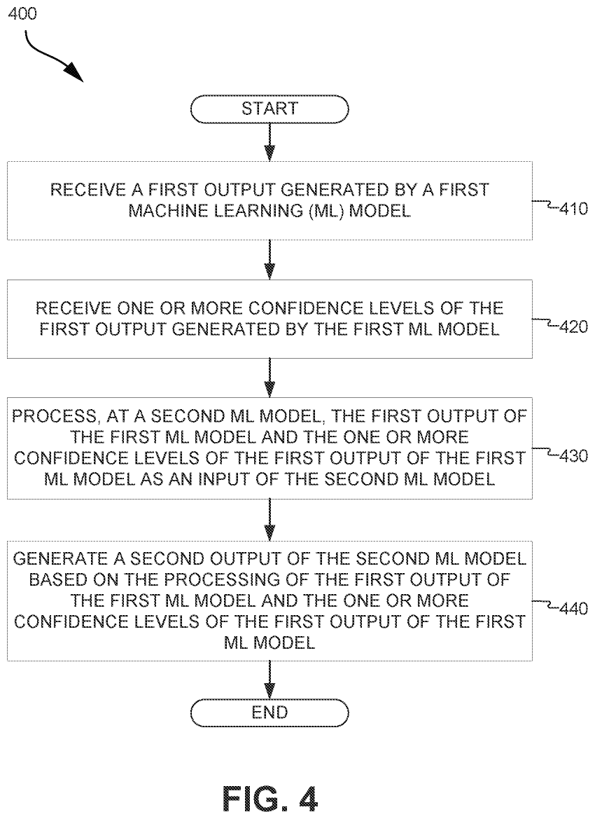

FIG. 4 illustrates a flowchart illustrating an example process 400 for detecting a translucent matter based on LIDAR returns. Although the example process 400 depicts a particular sequence of operations, the sequence may be altered without departing from the scope of the present disclosure. For example, some of the operations depicted may be performed in parallel or in a different sequence that does not materially affect the function of process 400. In other examples, different components of an example device or system that implements process 400 may perform functions at substantially the same time or in a specific sequence.

At block 410, process 400 can include receiving an output generated by a first ML model. For example, consumer 220 (e.g., a consumer ML model) can receive publisher output 212 generated by publisher 210 (e.g., a publisher ML model, a provider ML model, etc.) as illustrated in FIG. 2. In some examples, the output generated by the first ML model can include processed data based on sensor data provided as input to the first ML model. For example, publisher 210 may process sensor data 202 that is provided as input and generate publisher output 212.

As described previously, each of publisher 210 and consumer 220 may include one or more ML models such as an object detection model, an object classification model, a LIDAR-based model, a sensor fusion model, a path planning model, a control model, a semantic segmentation model, a behavior prediction model, a map generator model, etc.

At block 420, process 400 can include receiving a confidence level of the output generated by the first ML model. For example, consumer 220 can receive confidence level 214 associated with publisher output 212 as illustrated in FIG. 2. The confidence level 214 can provide consumer 220 with a degree of confidence/certainty relating to publisher output 212. In another example, object detection model 320 may receive error map 314 associated with depth map 312 that is generated by depth map model 310. The depth map 312 can comprise a depth value for each pixel. The error map 314 can comprise a probability of an error, a probability of uncertainty, or a probability of confidence/certainty for each pixel of depth map 312.

At block 430, process 400 can include processing, at a second ML model, the output of the first ML model and the confidence level of the output of the first ML model as an input of the second ML model. For example, consumer 220 can process publisher output 212 and confidence level 214. In another example, object detection model 320 may process depth map 312 and error map 314 to generate a 3D bounding box.

In some examples, processing the output of the first ML model and the confidence level of the output of the first ML model comprises processing at least a portion of the output of the first ML model based on the confidence level of the output of the first ML model. For example, if a confidence level associated with output of the first ML model includes a degree/probability of confidence/certainty, a portion of the output of the first ML model that has the degree of confidence above a confidence threshold can be processed to generate output of the second ML model. In another example, if a confidence level associated with output of the first ML model includes a degree/probability of uncertainty or error, a portion of the output of the first ML model that has the degree of uncertainty that is below an uncertainty threshold can be processed to generate output of the second ML model.

At block 440, process 400 can include generating an output of the second ML model based on the processing of the output of the first model and the confidence level of the output of the first ML model. For example, consumer 220 can generate consumer output 222 based on the processing of publisher output 212 and confidence level 214 associated with publisher output 212. In another example, object detection model 320 may generate 3D bounding box 322 based on the processing of depth map 312 and error map 314.

In some aspects, process 400 can include providing an output of the second ML model to a computing system associated with an AV. For example, consumer 220 can provide consumer output 222 to a computing system associated with an AV such as a perception stack of the AV, a prediction stack of the AV, a planning stack of the AV, a control stack of the AV, and/or a software system(s) of the AV (e.g., a cruise control system, a parking assistance system, a lane keeping system, a navigation system, a sensor processing and/or sensor fusion system, a collision and/or obstacle avoidance system, a path planning system, an autopilot system, a lane centering system, an electronic stability system, and/or any other system).

In some cases, an AV (e.g., AV 102) can implement chained machine learning models (e.g., a chain of publisher 210 and consumer 220 as illustrated in FIG. 2 or a chain of depth map model 310 and object detection model 320 as illustrated in FIG. 3) for performing autonomous driving operations. For example, a chain of ML models of the present disclosure can be implemented within various stacks of an AV (e.g., perception stack 112, localization stack 114, prediction stack 116, control stack 122, communications stack 120, planning stack 118, etc.).

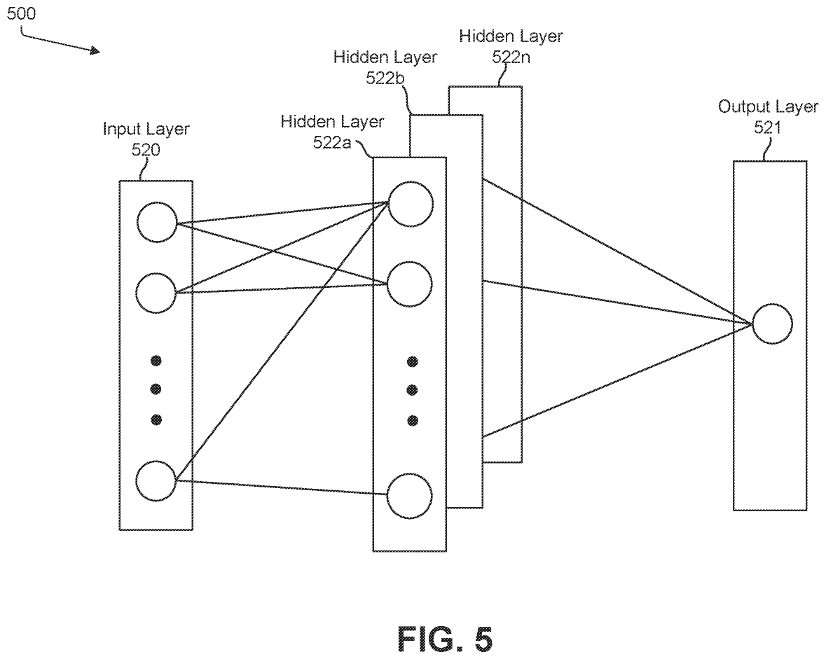

In FIG. 5, the disclosure now turns to a further discussion of models that can be used through the environments and techniques described herein. FIG. 5 is an example of a deep learning neural network 500 that can be used to implement all or a portion of the systems and techniques described herein (e.g., neural network 500 can be used to implement publisher 210, consumer 220, depth map model 310, and/or object detection model 320 as discussed above). An input layer 520 can be configured to receive sensor data and/or data relating to an environment surrounding an AV. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. Neural network 500 further includes an output layer 521 that provides an output resulting from the processing performed by the hidden layers 522a, 522b, through 522n.

Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communication interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: receive a first output generated by a first machine learning (ML) model; receive one or more confidence levels of the first output generated by the first ML model; process, at a second ML model, the first output of the first ML model and the one or more confidence levels of the first output of the first ML model as an input of the second ML model; and generate a second output of the second ML model based on the processing of the first output of the first ML model and the one or more confidence levels of the first output of the first ML model.

Aspect 2. The system of Aspect 1, wherein the one or more processors are configured to: provide the second output of the second ML model to a computing system associated with an autonomous vehicle.

Aspect 3. The system of Aspects 1 or 2, wherein processing the first output of the first ML model and the one or more confidence levels of the first output of the first ML model comprises: processing at least a portion of the first output of the first ML model based on the one or more confidence levels of the first output of the first ML model, wherein a respective confidence level from the one or more confidence levels corresponding to at least the portion of the first output of the first ML model exceeds a confidence threshold.

Aspect 4. The system of any of Aspect 1 to 3, wherein the one or more processors are configured to: train the second ML model with the second output of the second ML model, wherein training of the second ML model is independent of training of the first ML model.

Aspect 5. The system of any of Aspect 1 to 4, wherein the first ML model is trained with the first output of the first ML model and the one or more confidence levels of the first output, wherein training of the first ML model is independent of training of the second ML model.

Aspect 6. The system of any of Aspect 1 to 5, wherein the one or more confidence levels of the first output generated by the first ML model comprises a margin of error of the first output generated by the first ML model.

Aspect 7. The system of any of Aspect 1 to 6, wherein the first output of the first ML model includes a depth map comprising a depth value for each pixel of the depth map and the one or more confidence levels of the first output generated by the first ML model includes an error map indicative of a respective error for each pixel of the depth map.

Aspect 8. The system of Aspect 7, wherein the second output of the second ML model is based on one or more pixels of the depth map that have the respective error that is below an error threshold.

Aspect 9. The system of any of Aspect 1 to 8, wherein the first ML model includes at least one of an object detection model and an object classification model.

Aspect 10. A method comprising: receiving a first output generated by a first machine learning (ML) model; receiving one or more confidence levels of the first output generated by the first ML model; processing, at a second ML model, the first output of the first ML model and the one or more confidence levels of the first output of the first ML model as an input of the second ML model; and generating a second output of the second ML model based on the processing of the first output of the first ML model and the one or more confidence levels of the first output of the first ML model.

Aspect 11. The method of Aspect 10, further comprising: providing the second output of the second ML model to a computing system associated with an autonomous vehicle.

Aspect 12. The method of Aspects 10 or 11, wherein processing the first output of the first ML model and the one or more confidence levels of the first output of the first ML model comprises: processing at least a portion of the first output of the first ML model based on the one or more confidence levels of the first output of the first ML model, wherein a respective confidence level from the one or more confidence levels corresponding to at least the portion of the first output of the first ML model exceeds a confidence threshold.

Aspect 13. The method of any of Aspect 10 to 12, further comprising: training the second ML model with the second output of the second ML model, wherein training of the second ML model is independent of training of the first ML model.

Aspect 14. The method of any of Aspect 10 to 13, wherein the first ML model is trained with the first output of the first ML model and the one or more confidence levels of the first output, wherein training of the first ML model is independent of training of the second ML model.

Aspect 15. The method of any of Aspect 10 to 14, the one or more confidence levels of the first output generated by the first ML model comprises a margin of error of the first output generated by the first ML model.

Aspect 16. The method of any of Aspect 10 to 15, wherein the first output of the first ML model includes a depth map comprising a depth value for each pixel of the depth map and the one or more confidence levels of the first output generated by the first ML model includes an error map indicative of a respective error for each pixel of the depth map.

Aspect 17. The method of Aspect 16, wherein the second output of the second ML model is based on one or more pixels of the depth map that have the respective error that is below an error threshold.

Aspect 18. The method of any of Aspect 10 to 17, wherein the first ML model includes at least one of an object detection model and an object classification model.

Aspect 19. A non-transitory computer-readable medium comprising instructions which, when executed by one or more processors, cause the one or more processors to perform a method according to any of Aspects 10 to 18.

Aspect 20. A system comprising means for performing according to any of Aspects 10 to 18.

Aspect 21. The system of Aspect 20, wherein the system comprises an autonomous vehicle.

Aspect 22. A computer-program product including instructions which, when executed by one or more processors, cause the one or more processors to perform a method according to any of Aspects 10 to 18.

What is claimed is:

1. A system comprising:
a memory; and
one or more processors coupled to the memory, the one or more processors being configured to:
receive a first output generated by a first machine learning (ML) model;
receive one or more confidence levels of the first output generated by the first ML model;
process, at a second ML model, the first output of the first ML model and the one or more confidence levels of the first output of the first ML model as an input of the second ML model; and
generate a second output of the second ML model based on the processing of the first output of the first ML model and the one or more confidence levels of the first output of the first ML model.

2. The system of claim 1, wherein the one or more processors are configured to:
provide the second output of the second ML model to a computing system associated with an autonomous vehicle.

3. The system of claim 1, wherein processing the first output of the first ML model and the one or more confidence levels of the first output of the first ML model comprises:
processing at least a portion of the first output of the first ML model based on the one or more confidence levels of the first output of the first ML model, wherein a respective confidence level from the one or more confidence levels corresponding to at least the portion of the first output of the first ML model exceeds a confidence threshold.

4. The system of claim 1, wherein the one or more processors are configured to:
train the second ML model with the second output of the second ML model, wherein training of the second ML model is independent of training of the first ML model.

5. The system of claim 1, wherein the first ML model is trained with the first output of the first ML model and the one or more confidence levels of the first output, wherein training of the first ML model is independent of training of the second ML model.

6. The system of claim 1, wherein the one or more confidence levels of the first output generated by the first ML model comprises a margin of error of the first output generated by the first ML model.

7. The system of claim 1, wherein the first output of the first ML model includes a depth map comprising a depth value for each pixel of the depth map and the one or more confidence levels of the first output generated by the first ML model includes an error map indicative of a respective error for each pixel of the depth map.

8. The system of claim 7, wherein the second output of the second ML model is based on one or more pixels of the depth map that have the respective error that is below an error threshold.

9. The system of claim 1, wherein the first ML model includes at least one of an object detection model and an object classification model.

10. A method comprising:
receiving a first output generated by a first machine learning (ML) model;
receiving one or more confidence levels of the first output generated by the first ML model;
processing, at a second ML model, the first output of the first ML model and the one or more confidence levels of the first output of the first ML model as an input of the second ML model; and
generating a second output of the second ML model based on the processing of the first output of the first ML model and the one or more confidence levels of the first output of the first ML model.

11. The method of claim 10, further comprising:
providing the second output of the second ML model to a computing system associated with an autonomous vehicle.

12. The method of claim 10, wherein processing the first output of the first ML model and the one or more confidence levels of the first output of the first ML model comprises:
processing at least a portion of the first output of the first ML model based on the one or more confidence levels of the first output of the first ML model, wherein a respective confidence level from the one or more confidence levels corresponding to at least the portion of the first output of the first ML model exceeds a confidence threshold.

13. The method of claim 10, further comprising:
training the second ML model with the second output of the second ML model, wherein training of the second ML model is independent of training of the first ML model.

14. The method of claim 10, wherein the first ML model is trained with the first output of the first ML model and the one or more confidence levels of the first output, wherein training of the first ML model is independent of training of the second ML model.

15. The method of claim 10, the one or more confidence levels of the first output generated by the first ML model comprises a margin of error of the first output generated by the first ML model.

16. The method of claim 10, wherein the first output of the first ML model includes a depth map comprising a depth value for each pixel of the depth map and the one or more confidence levels of the first output generated by the first ML model includes an error map indicative of a respective error for each pixel of the depth map.

17. The method of claim 16, wherein the second output of the second ML model is based on one or more pixels of the depth map that have the respective error that is below an error threshold.

18. The method of claim 10, wherein the first ML model includes at least one of an object detection model and an object classification model.

19. A non-transitory computer-readable medium comprising instructions which, when executed by one or more processors, cause the one or more processors to:
receive a first output generated by a first machine learning (ML) model;
receive one or more confidence levels of the first output generated by the first ML model;
process, at a second ML model, the first output of the first ML model and the one or more confidence levels of the first output of the first ML model as an input of the second ML model; and
generate a second output of the second ML model based on the processing of the first output of the first ML model and the one or more confidence levels of the first output of the first ML model.

20. The non-transitory computer-readable medium of claim 19, comprising further instructions configured to cause the one or more processors to:
provide the second output of the second ML model to a computing system associated with an autonomous vehicle.
